(19) United States
(12) Patent Application Publication
(10) Pub. No.: US 2008/0265114 A1
(43) Pub. Date: Oct. 30, 2008

(54) Modular LCD Display System

(76) Inventor: Jerry Moscovitch, Toronto (CA)

Correspondence Address: MASS ENGINEERED DESIGN INC., 474 WELLINGTON STREET WEST, TORONTO, ON, M5V-1E3, CA

(21) Appl. No.: 12/164,734

(22) Filed: Jun. 30, 2008

Related U.S. Application Data
(63) Continuation of application No. 10/129,883, filed on May 10, 2002, now abandoned.
(60) Provisional application No. 60/165,340, filed on Nov. 12, 1999.

(51) Int. Cl. F16M 11/00

(52) U.S. Cl. 248/176.3

(57) ABSTRACT

A modular multi-screen LCD display system. In one embodiment the display system comprises four independent LCD screens supported on first and second independent T-shaped support arms. The first T-shaped support arm is supported by a base assembly, and the second T-shaped support arm is supported above the first T-shaped support arm by a vertical spacing arm. An adapter is included which allows the display system to be reconfigured for use with a single LCD screen or with three LCD screens. In an alternative embodiment a central T-shaped support arm is used to support two outer T-shaped support arms at opposite ends thereof. The outer T-shaped support arms are arranged vertically such that the three support arms form an “H” shape. A pair of LCD screens are mounted on each outer T-shaped support arm. This configuration permits four LCD screens to be mounted much closer to a work surface.

### TECHNICAL FIELD

This invention relates to display systems for computers, and more particularly to a modular, multi-screen display system for use with a computer system, where the multi-screen display system includes anywhere from one through four or more independent liquid crystal display screens disposed adjacently to one another on one or more support arms.

### BACKGROUND OF THE INVENTION

Multi-screen displays are becoming more and more popular for use in various businesses, such as in financial institutions, stock market brokerage firms, engineering companies and the like. These displays are commonly coupled to a single computer and capable of displaying various graphs, charts and other important information simultaneously. Thus, a large amount of data or information can be displayed to the user at any given time, and without the user having to partially cover portions of the information in a “windowed” or layered arrangement, as would be necessary with only a single display screen.

Up until the present, most multi-screen display systems have been limited to two independent display screens positioned side-by-side. The angle of the screens relative to each other has usually not been adjustable, and often the displays have been required to be set directly on a table or desk, thereby using a significant amount of desk or table space. To date, there has not been a convenient and efficient means to provide three or more independent display screens, let alone to provide a modularly expandable display system which can be used to support four or more screens in a manner which minimizes the footprint area of the system, and which still allows each of the screens to be adjusted slightly such that each can be angled or “booked” toward each other to further enhance the ease with which information can be viewed on each of the screens.

It is therefore an object of the present invention to provide a display system for use with a computer system, where the display system incorporates four independent display screens supported on a pair of common horizontal support arms, and elevated by a support column, so as significantly reduce the footprint area required by the display system.

It is another object of the present invention to provide a display system for use with a computer system, where the display system incorporates four independent liquid crystal display (LCD) screens mounted on a pair of vertically disposed support arms. It is still another object of the present invention to provide a display system for use with a computer system, where the display system incorporates four independent LCD screens, and wherein each of the screens are capable of being angled or “booked” toward each other to optimize the viewing angle of the screens relative to the user.

It is still another object of the present invention to provide a display system which can be modularly configured to provide between one through four, or more, LCD display screens, through the use of an adapter, in a manner that does not require time consuming procedures to so modify the system.

### SUMMARY OF THE INVENTION

The above objects are provided by a modular display system in accordance with preferred embodiments of the present invention. In one embodiment the display system comprises a base system, a vertical support arm, a first T-shaped support arm, a second T-shaped support arm, and an upper vertical spacing arm. The two T-shaped support arms each have a pair of display screen docking stations where a pair of liquid crystal display (LCD) screens can be secured to. Preferably, each docking station includes a ball joint assembly which permits its associated LCD screen to be angled or “booked” toward the user to thus optimize viewing thereof by the user. The second T-shaped support arm is supported above the first by the upper vertical spacing arm. The first T-shaped support arm includes a neck portion having a support member which fits within a recess in the vertical support arm.

In a preferred embodiment an adapter is provided which enables the entire display system to be reconfigured to be used with only a single LCD screen or with three LCD screens. The adapter has a support member adapted to engage within the recess of the vertical support member and a docking station for supporting an LCD screen, preferably via a ball joint interposed therebetween.

In yet another alternative preferred embodiment the display system of the present invention includes a central T-shaped support arm which supports at its opposite ends thereof a pair of outer T-shaped support arms. Each of the outer T-shaped support arms has a docking station at its outermost end for supporting an LCD screen. Thus, each outer T-shaped, support arm is able to support a pair of LCD screens thereon, and to present the LCD screens much closer to a surface on which the display system is resting.

### BRIEF DESCRIPTION OF THE DRAWINGS

The various advantages of the present invention will become apparent to one skilled in the art by reading the following specification and subjoined claims and by referencing the following drawings in which:

FIG. 1 is a front view of a four LCD screen display system in accordance with a preferred embodiment of the present invention.

FIG. 2 is a front perspective view of the four LCD screen display system of FIG. 1 but without the LCD screens attached;

FIG. 3 is a rear perspective view of the system shown in FIG. 2;

FIG. 4 is a side perspective view of the system shown in FIG. 2;

FIG. 5 is a perspective view of the display system of FIG. 2 in a disassembled state so as to more clearly illustrate its various components;

FIG. 6 is a perspective view of the display system of FIG. 2 with the two T-shaped support arms ready to be attached to each other and to the vertical support arm;

FIG. 7 is a rear view of the adapter of the present invention used to convert the display system from a four screen system to a one screen system;

FIG. 8 is a side view of the adapter of FIG. 7;

FIG. 9 is a perspective view of the adapter disposed adjacent the vertical support column ready for attachment thereto;

FIG. 10 is a top perspective view of the adapter secured to the vertical support column;

FIG. 11 is a front perspective view of the adapter of FIG. 10;

FIG. 12 is a rear perspective view of the adapter of FIG. 10;

FIG. 13 is a rear perspective view of a single screen LCD display system in accordance with the present invention configured with the use of the adapter of FIGS. 7 and 8;

FIG. 14 is a front perspective view of an alternative preferred embodiment of the present invention;

FIG. 15 is a front perspective view of the display system shown in FIG. 14 but without the LCD screens attached thereto;

FIG. 16 is a rear perspective view of the display system shown in FIG. 15;

FIG. 17 is a side perspective view of the display system shown in FIG. 15; and;

FIG. 18 is a view of the various components of the support system of FIG. 15 positioned for attachment to one another;

### DETAILED DESCRIPTION OF THE PREFERRED EMBODIMENTS

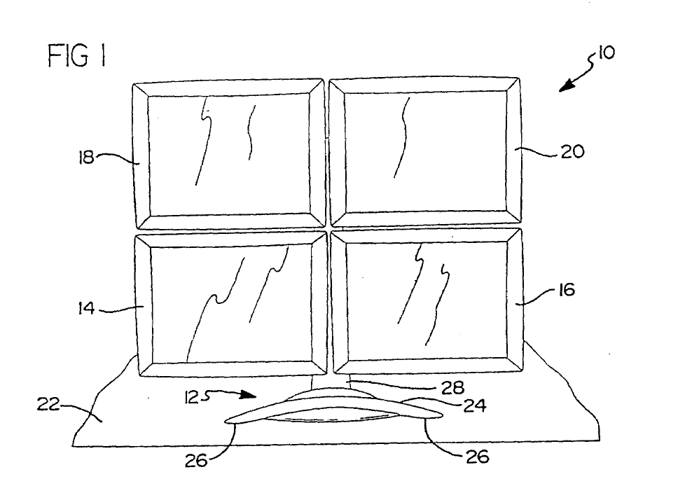

Referring to FIG. 1, there is shown a four screen liquid crystal display (LCD) display system 10 in accordance with a preferred embodiment of the present invention. The display system 10 includes a base assembly 12 which supports all four screens 14, 16, 18 and 20 in an elevated manner above a work surface 22. The base assembly 12 includes a base member 24 having a pair of support feet 26 extending outwardly therefrom and a vertical support column 28 fixedly secured thereto. The base member 24 preferably includes a heavy piece of material, such as lead, which is insert molded or otherwise attached thereto to provide resistance against tipping or leaning of the display system 10.

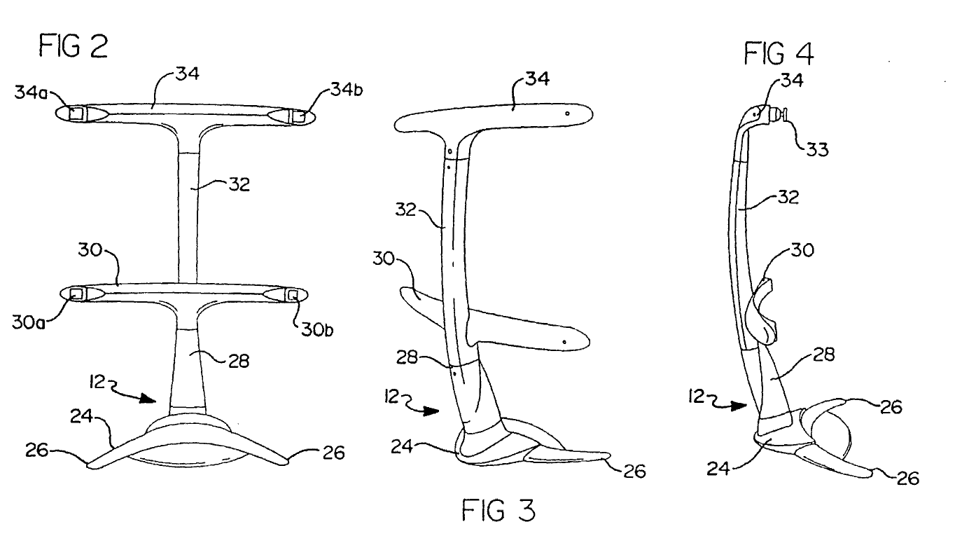

Referring to FIGS. 2-4, the display system 10 can be seen without the LCD screens 14-20 secured thereto. A first T-shaped support arm 30 is fixedly secured to the vertical support column 28. An upper vertical spacing arm 32 is secured at one end to the first T-shaped support arm 30 and at its opposite end to a second T-shaped support arm 34. The first T-shaped support arm includes a pair of docking stations 34a and 34b to which suitable ball joints (not shown) are preferably attached. The ball joints are then secured to the rear of the LCD screens 14 and 16, respectively. Similarly, the second T-shaped support arm 34 includes docking stations 34a and 34b. A pair of ball joints are preferably secured to the docking stations 30a and 30b and to the rear portion of LCD screens 18 and 20, respectively.

With specific reference to FIGS. 3 and 4, it will be noted that the T-shaped support arms 30 and 34 each are “bowed” or arched slightly. The radius of curvature is preferably within a range of about 24″-36″, and more preferably about 30″, which has been found to economically maximize the convenience to the user in viewing the LCD screens. This enables the two LCD screens disposed thereon to be presented in a slightly “booked” fashion (i.e., angled towards each other slightly) to ease viewing of the screens. The ball joints enable an added degree of adjustability in optimizing the viewing angle of each screen, but it will be understood that the ball joints are optional. One such ball joint 33 is shown in simplified form in FIG. 4.

From FIGS. 3 and 4 it will be noted that the vertical support column and the upper vertical spacing arm 32 together form a slightly curving structure. This further helps to optimize the stability of the overall support system 12.

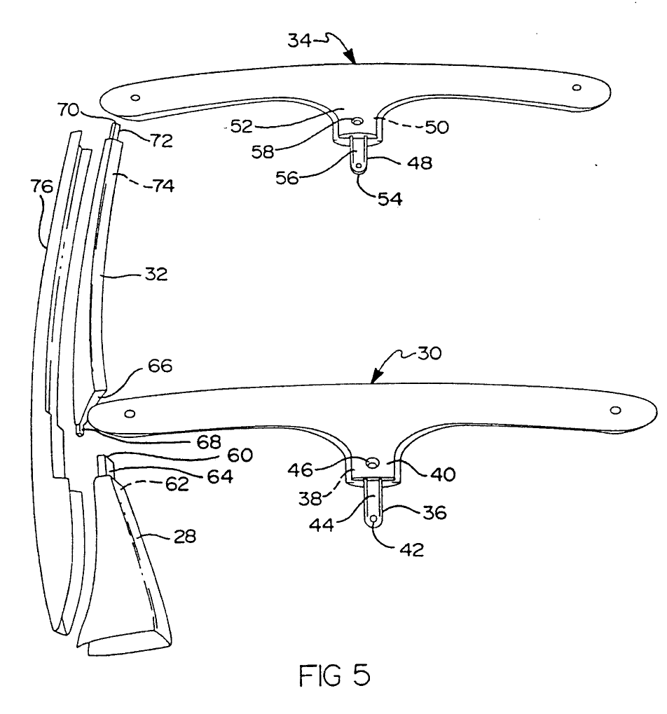

Referring now to FIG. 5, the display system 10 can be seen without the LCD screens 14-20 and without the base member 24 attached thereto. The first T-shaped support arm 30 includes a support member 36 projecting therefrom and a recess 38 formed within a neck portion 40 thereof. The support member 36 includes apertures 42 and 44, while the neck portion 40 includes an aperture 46. The second T-shaped support arm 34 is essentially identical in construction and includes a projecting support member 48 and a recess 50 formed in a neck portion 52 thereof. The support member 48 includes apertures 54 and 56 while the neck portion 52 includes an aperture 58.

Referring further to FIG. 5, the vertical support column 28 also includes a support member 60 and a recess 62 adjacent the support member. The support member 60 includes an aperture 64. The recess 62 is adapted to receive the support member 36, while recess 38 receives the support member 60 therein when the first T-shaped support arm 30 is secured to the vertical support column 28.

The upper vertical spacing arm 32 includes at a lower end portion a curving attachment portion 66 and an aperture 68, and at an opposite end a support member 70 having an aperture 72. A recess 74 is also formed adjacent the support member 70 and adapted to receive the support member 54 of the second T-shaped support arm 34, while the support member 70 engages within the recess 50 in the T-shaped support arm 34. A cover 76 having a plurality of apertures 78 is attachable to the vertical support column 28 and to the upper vertical spacing arm 32.

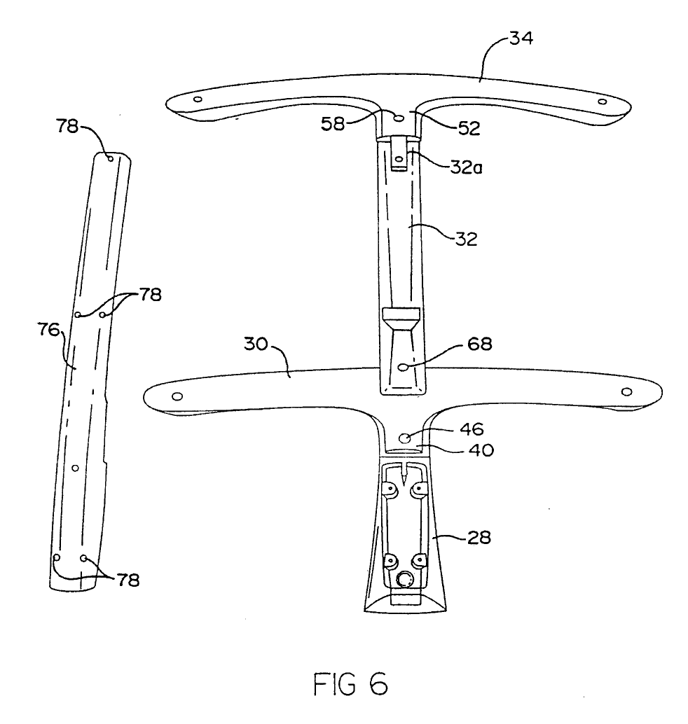

Referring to FIG. 6, the components just described in connection with FIG. 5 are shown disposed in position to be secured together by a suitable number of external fastening elements (not shown) such as threaded fasteners placed in the apertures 42, 44, 46, 54, 56, 58, 64, 68, 72 and 78.

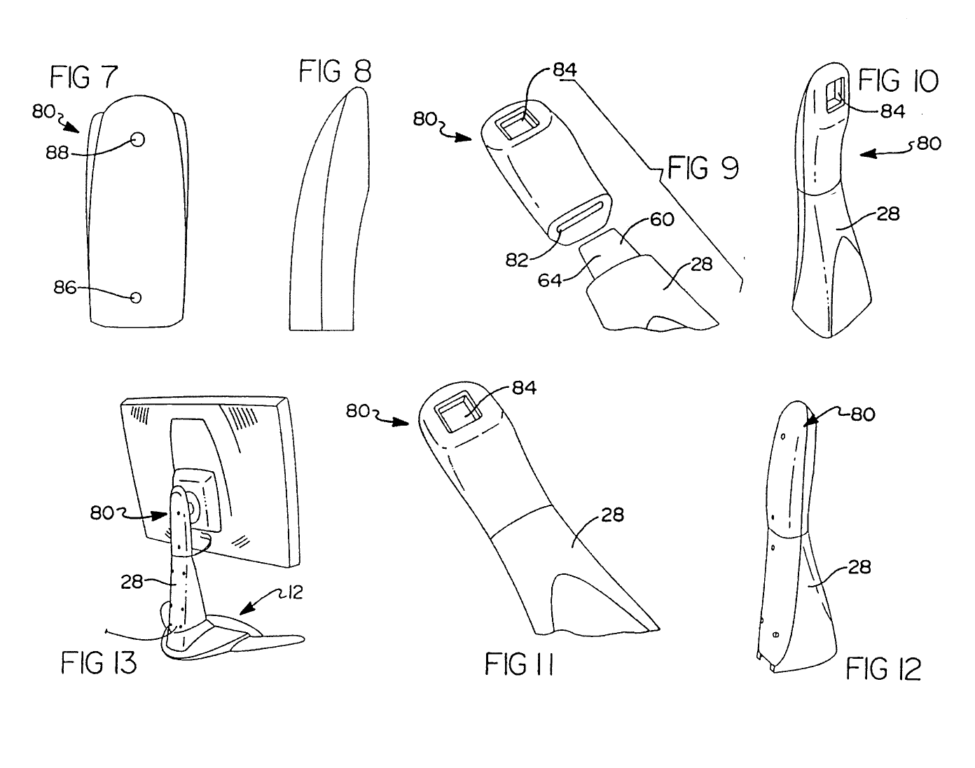

Referring now to FIGS. 7-12, an adapter 80 is shown for enabling the display system 10 to be configured for use with only a single LCD screen, or for modifying the display system 10 to be used with only three LCD screens. The adapter 80 includes a recess 82 and a docking station 84. A pair of apertures 86 and 88 are also formed for enabling external fastening elements to be used to secure the adapter to either the vertical support column 28 or to the upper end 32a (FIG. 6) of the upper vertical spacing arm 32. By removing the second T-shaped support arm 34 and securing the adapter 80 to the upper end 32a, the display system 10 can be configured to support three LCD screens instead of four, and without requiring any modification to the placement of the two LCD screens mounted on the first T-shaped support arm 30. Alternatively, the display system 10 could be easily converted to use as a single LCD screen system by removing the first T-shaped support arm 30 and the other support arms attached thereto, and attaching the adapter 80 directly to the vertical support column 28 such that the support member 60 is received in recess 82. Thus, the adapter 80 allows the display system 10 to be altered, in a modular fashion, to reconfigure the system 10 for use as a single or triple LCD screen display system. The single screen configuration, using the adapter 80, is shown in FIG. 13. It will also be appreciated that the docking station 84 will preferably incorporate a suitable ball joint for permitting adjustment of its LCD screen attached thereto.

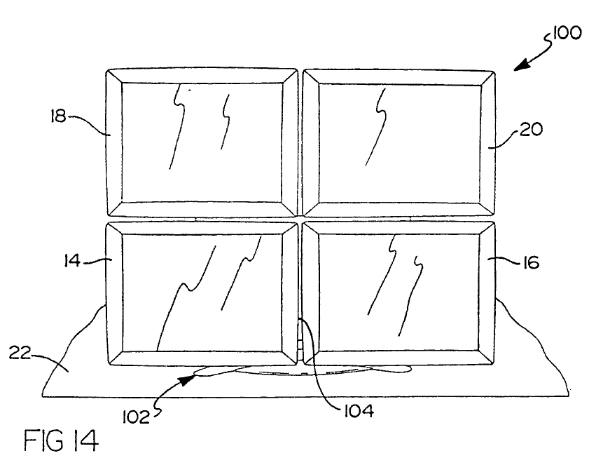

Referring now to FIG. 14, a four screen LCD display system 100 in accordance with an alternative preferred embodiment of the present invention is shown. This embodiment is somewhat similar to the display system 10 and also makes use of a base assembly 102 having a vertical support column 104 for supporting the four LCD screens 14-20. The principal advantage of the system 100 is that it is able to support the screens 14-20 much closer to the surface 22 on which the base assembly 102 rests.

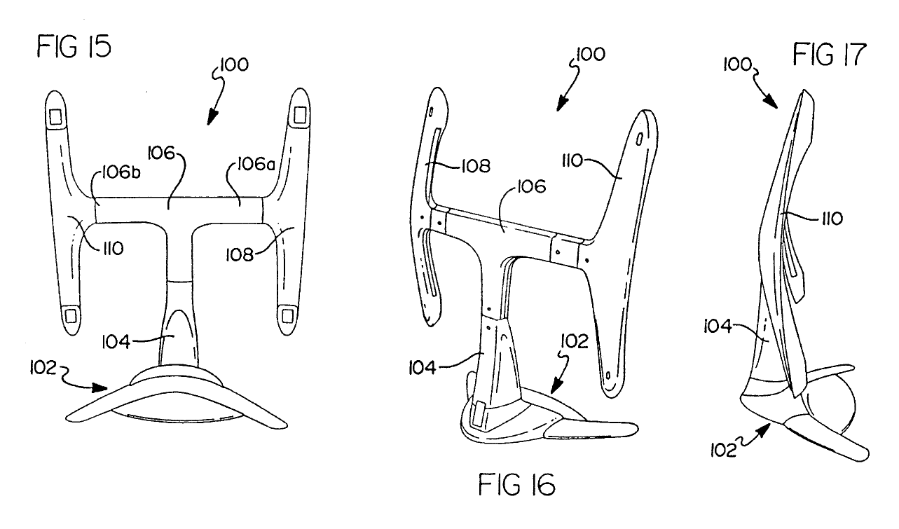

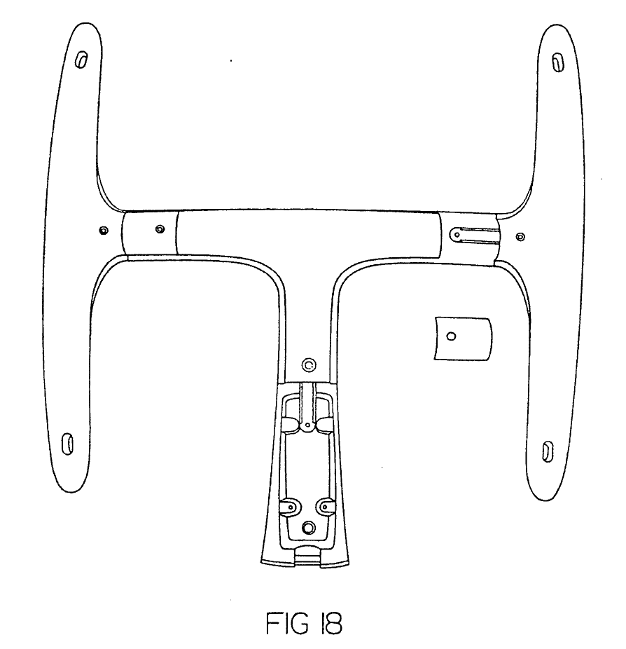

Referring to FIGS. 15-17, the vertical support column can be seen to be secured to a central, T-shaped support arm 106. The opposite ends 106a and 106b of the support arm 106 are in turn secured to outer T-shaped support arms 108 and 110. The resulting structure forms a somewhat “H” shape that presents the four LCD screens 14-20 much closer to the surface 22 on which the system 100 is supported. It will be appreciated that the base assembly 102 and it vertical support column 104 are identical to the base assembly 12 and support column 28 of the system 10 described previously. The support arms 106, 108 and 110 also each incorporate recesses and mounting members identical to those of the system 10 as shown in FIGS. 5 and 6 and described herein.

The apparatus of the present invention thus provides a modularly configurable LCD display system. The system can be configured for one, two, three, four or even more LCD screens. Obviously, more than four screens may require enlargement of the base assembly 12 or 102 to ensure stability.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A modular support system for display screens, the system comprising:
a base;
a first arm coupled to the base for supporting a first pair of display screens, said first arm being substantially horizontal;
a vertical spacing arm coupled to at least one of the base and the first arm; and
a second arm coupled to the vertical spacing arm for supporting a second pair of display screens, the second arm being substantially horizontal and substantially disposed above the first arm, wherein the second arm may be readily decoupled from the vertical spacing arm to transform the system from a four screen support system for supporting the first and second pairs of display screens, into a three screen support system for supporting the first pair of display screens and an additional display screen.

2. The modular support system of claim 1, wherein the first arm is substantially identical to the second arm and wherein, assembled as the four screen support system, the first arm is adapted to support the first pair of display screens in a horizontal arrangement and the second arm is adapted to support the second pair of display screens in a horizontal arrangement above the first pair.

3. The system of claim 1, wherein the vertical spacing bar can be readily decoupled from the at least one of the base and the first arm, and the first arm can be readily decoupled from the base to transform the system from a four screen support system for supporting the first and second pairs of display screens, into a one screen support system for supporting one display screen.

4. The system of claim 3, further comprising an adapter, wherein, in the three screen support system, the adapter is coupled to the vertical spacing arm to support the additional display screen, and, in the one screen support system, the adapter is coupled to the base for supporting the one display screen.

5. The system of claim 1, further comprising at least one display screen that is supportable by at least one of the first arm and the second arm.

6. The system of claim 5, wherein the at least one display screen is a liquid crystal display screen.

7. The system of claim 6, further comprising a first pair of docking stations for securing the first pair of display screens to the first support arm, and a second pair of docking stations for securing the second pair of display screens to the second support arm.

8. The system of claim 7, wherein the first pair of docking stations secure rear portions of the first pair of display screens to the first support arm, and the second pair of docking stations secure rear portions of the second pair of display screens to the second support arm.

9. The system of claim 8, wherein the base is adapted to rest on a work surface.

10. The system of claim 1, further comprising a first pair of docking stations for securing the first pair of display screens to the first support arm, and a second pair of docking stations for securing the second pair of display screens to the second support arm.

11. The system of claim 10, wherein the first pair of docking stations secure rear portions of the first pair of display screens to the first support arm and the second pair of docking stations secure rear portions of the second pair of display screens to the second support arm.

12. The system of claim 11, wherein the base is adapted to rest on a work surface.

13. The system of claim 1, wherein the first arm and the second arm are T-shaped.

14. A modular support system for display screens, the system comprising:
a base;
a vertical arm coupled to base;
a first arm disposed above the base for supporting a first pair of display screens, said first arm being substantially horizontal; and
a second arm coupled to the vertical arm for supporting a second pair of display screens, the second arm being substantially horizontal and substantially disposed above the first arm, wherein the second arm may be readily decoupled from the vertical arm to transform the system from a four screen support system for supporting the first and second pairs of display screens, into a three screen support system for supporting the first pair of display screens and an additional display screen.

15. The system of claim 14, further comprising an adapter for supporting the additional display screen, wherein, after the second arm is decoupled from the vertical arm, the adapter is coupled to the vertical arm to support the additional display screen.

16. The system of claim 15, wherein the vertical arm includes a projection at the top thereof for mating with the adapter.

17. The system of claim 15, wherein the base is adapted to rest on a work surface.

18. A modular support system for display screens, the system comprising:
a base;
a first arm coupled to the base for supporting a pair of display screens, said first arm being substantially horizontal;
a vertical spacing arm coupled to at least one of the base and the first arm; and
an adapter coupled to the vertical spacing arm for supporting a third display screen above the pair of display screens, wherein the vertical spacing arm may be readily decoupled from the at least one of the base and the first arm to transform the system from a three screen support system for supporting the pair and third display screens, into a two screen support system for supporting the pair of display screens.

19. The modular system of claim 18, wherein a) the first arm and the vertical spacing bar may be decoupled from the base, and b) after decoupling the adapter from the vertical spacing arm, the adapter may be coupled to the base to transform the system from a three screen support system for supporting the pair and third display screens, into a one screen support system for supporting the third display screen.

20. The modular system of claim 18, wherein a) the first arm may be decoupled from the base, and b) after decoupling the adapter from the vertical spacing arm, the adapter may be coupled to the base to transform the system from a three screen support system for supporting the pair and third display screens, into a one screen support system for supporting the third display screen.
